(19) United States
(12) Patent Application Publication
(10) Pub. No.: US 2012/0244820 A1
(43) Pub. Date: Sep. 27, 2012

(54) APPARATUS AND METHOD FOR CONTROLLING ELECTRONIC APPARATUS

(75) Inventor: Nobuaki TAKASU, Tokyo (JP)

(73) Assignee: KABUSHIKI KAISHA TOSHIBA, Tokyo (JP)

(21) Appl. No.: 13/407,041

(22) Filed: Feb. 28, 2012

(30) Foreign Application Priority Data
Mar. 22, 2011 (JP) 2011-061992

(51) Int. Cl. H01Q 19/17; H04B 1/38

(52) U.S. Cl. 455/73; 343/834

(57) ABSTRACT

An electronic apparatus includes: an antenna module configured to transmit and receive communication waves in a first direction; and a switching module disposed at a position in front of the antenna module, the switching module being configured to electrically switch a direction of the communication waves in the first direction and in a second direction that is different from the first direction.

### CROSS-REFERENCE TO THE RELATED APPLICATION(S)

The present application is based upon and claims priority from prior Japanese Patent Application No. 2011-061992, filed on Mar. 22, 2011, the entire contents of which are incorporated herein by reference.

### FIELD

Embodiments described herein relate generally to an electronic apparatus and a method for controlling electronic apparatus.

### BACKGROUND

In recent years, electromagnetic waves, called millimeter waves, have been used in wireless communications.

Millimeter waves are radio waves having a frequency band between 30 GHz to 300 GHz, even in electromagnetic waves. In other words, because a wavelength is approximately between 10 mm (30 GHz) to 1 mm (300 GHz), these waves are known as millimeter waves (extremely high frequency, or EHF).

For example, a frequency of communication waves used in telecommunications on a cell phone and the like, is on the order of approximately between 1.7 GHz to 2 GHz. However, millimeter wave frequency is on the order of several 10's to several hundreds of times that frequency. For that reason, it is possible to use wide bands. If the communication is a short distance, it is possible to implement high-speed wireless communications exceeding 1 Gbps, for example.

Also, in millimeter wave communications (transmitting and receiving millimeter waves), millimeter waves have strong straightness and directivity characteristics that are close to optical characteristics, so the direction (range) that communication can be implemented is limited.

For that reason, beam forming and the like are performed using an array antenna, for example.

However, normally a direction (range) that communication is possible with an array antenna is to the degree of 60°. Even if implementing beam forming and the like mentioned above, communication is possible to a degree of 160°. For that reason, communication radio waves do not reach a direction just beside or a direction behind (opposite) an array antenna exceeding 160°. In such a case, it was not possible to verify the party of a communication.

For example, it is possible to increase a direction (range) that communications are possible, such as by disposing multiple array antenna to make it easier to verify the other party of the communication.

However, this causes the problems of increased product cost if a number of array antennas used in an electronic apparatus is increased, and increased power consumption because power is consumed by multiple array antenna.

For those reasons, there are the issues of reducing a number of array antenna used while making it easy to verify another party of the communication.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is an explanatory view of one example of data communications using a radio wave having strong directivity, performed by an electronic apparatus and another electronic apparatus.

FIG. 2 is an external view of one example of an electronic apparatus according to an embodiment of the present invention;

FIG. 3 is a block diagram to explain one example of a configuration of an electronic apparatus according to the embodiment of the present invention.

FIG. 4 is an explanatory view of one example of a configuration of an electronic apparatus according to the embodiment of the present invention.

FIG. 5 is an explanatory view of another example of a configuration of an electronic apparatus according to the embodiment of the present invention.

FIG. 6 is an explanatory view of another example of a configuration of an electronic apparatus according to the embodiment of the present invention.

FIG. 7 is a flow chart to explain one example of behavior of an electronic apparatus according to the embodiment of the present invention.

### DETAILED DESCRIPTION

According to the embodiments described herein, there is provided an electronic apparatus including: an antenna module configured to transmit and receive communication waves in a first direction; and a switching module disposed at a position in front of the antenna module, the switching module being configured to electrically switch a direction of the communication waves in the first direction and in a second direction that is different from the first direction.

Preferred embodiments of the invention will now be described with reference to the drawings provided.

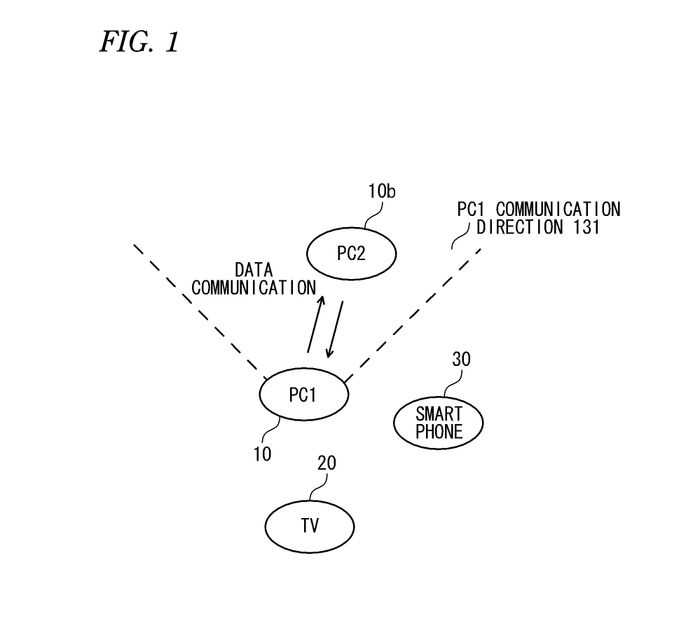

FIG. 1 is an explanatory view of one example of data communications using a radio wave having strong directivity, performed by an electronic apparatus and another electronic apparatus.

The numeral 10 denotes an electronic apparatus that implements data communication using a radio wave having strong directivity, such as a millimeter wave, for example. Here, the explanation uses a personal computer (PC1) as an example. The numeral 10b denotes another electronic apparatus (PC2). Electronic apparatus 10 and this electronic apparatus (PC2) 10b perform data communications using millimeter waves.

The numeral 131 denotes a direction that communication is possible using millimeter waves that are radio waves having strong directivity, in the electronic apparatus (PC1) 10. Here, in other words, this is a direction in which communication is possible with another electronic apparatus of the personal computer (PC1).

As shown in the drawing, the electronic apparatus (PC2) 10b is in the communication direction of PC1 which is a direction in which communication is possible using millimeter waves of electronic apparatus (PC1) 10. For that reason, it is possible for the electronic apparatus (PC1) 10 and the electronic apparatus (PC2) 10b to communicate using millimeter waves that are radio waves having strong directivity.

The numeral 20 denotes an electronic apparatus (TV); the numeral 30 denotes an electronic apparatus (a smart-phone).

As shown in the drawing, here, the electronic apparatus (TV) 20 and electronic apparatus (smart-phone) 30 are not in the communication direction of PC1 which is a direction in which communication is possible using millimeter waves of electronic apparatus (PC1) 10. For that reason, the electronic apparatus (TV) 20 and electronic apparatus (smart-phone) 30 are in a state where millimeter wave communication cannot be implemented with the electronic apparatus (PC1) 10.

In this way, when communicating using radio waves having strong directivity, such as with millimeter wave communications, a direction (range) in which communication is possible with another electronic apparatus is limited.

In this embodiment, as described below, it is easier to verify another party of the communication (another electronic apparatus) by electrically switching a direction that communication waves of an electronic apparatus (PC) 10 are transmitted and received, for example.

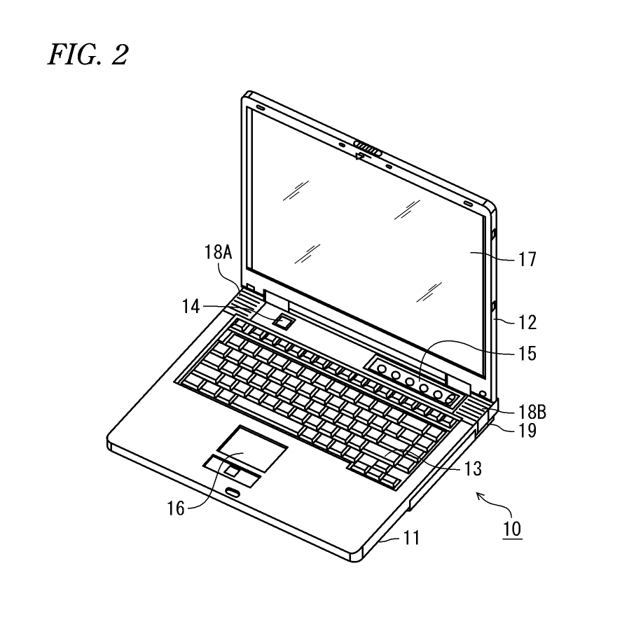

FIG. 2 is an external view of one example of an electronic apparatus according to an embodiment of the present invention.

Here, the electronic apparatus is implemented as a personal computer (laptop PC) a notebook type for example.

Note that this embodiment is not limited to a personal computer. The invention also can be applied to any portable electronic apparatus such as a television, or cellular telephone and the like.

As shown in the FIG. 2, this electronic apparatus (laptop PC) 10 is composed of a computer (laptop PC) main body case 11, and an image display portion (display unit) 12. A liquid crystal display (LCD) 17, for example, is built into an image display portion (display unit) 12.

The image display portion (display unit) 12 is mounted to the computer (laptop PC) main body case 11, and is rotatable between and open position in which an upper surface of the computer (laptop PC) main body case 11 is exposed, and a closed position that covers the upper surface of the computer (laptop PC) main body case 11.

The computer (laptop PC) main body case 11 has a thin box-shaped case, for example. A keyboard 13, a power button 14 for turning the electronic apparatus (laptop PC) 10 on and off, an input operation panel 15, a touch-pad 16, and speakers 18A and 18B and the like are disposed on the surface of the case 11. Various operation buttons are disposed at the input operation panel 15.

Also, a USB (universal serial bus) connector 19 for connecting a USB 2.0-standard USB cable or USB device is provided on a right side surface of the computer (laptop PC) main body case 11.

Still further, an external display connection terminal (not shown) that supports HDMI (high-definition multimedia interface), for example, is disposed at a back-side surface of the computer (laptop PC) main body case 11. This external display connection terminal is used to output digital image signals to an external display.

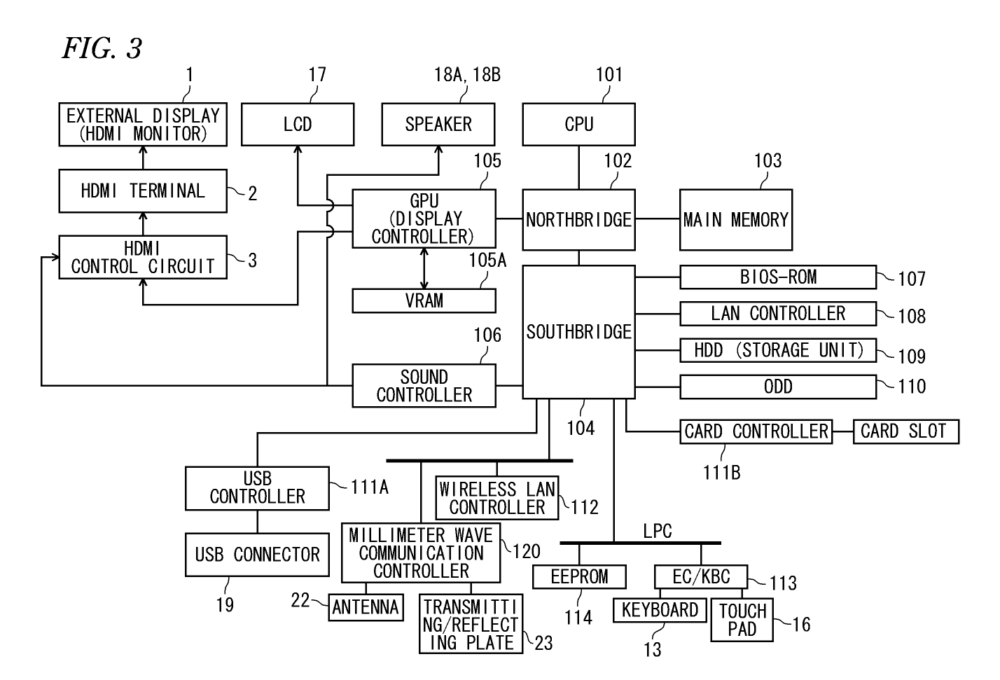

FIG. 3 is a block diagram showing a configuration of an electronic apparatus (laptop PC) according to an embodiment of the present invention.

As shown in FIG. 2, the electronic apparatus (laptop PC) 10 is equipped with a CPU (central processing unit) 101, a Northbridge 102, a main memory 103, a Southbridge 104, a GPU (graphics processing unit) 105, a VRAM (video RAM: random access memory) 105A, a sound controller 106, a BIOS-ROM (basic input/output system-read only memory) 107, A LAN (local area network) a controller 108, hard disk drive (HDD (storage unit)) 109, and optical disk drive (ODD) 110, a USB controller 111A, a card controller 111B, a wireless LAN controller 112, an embedded controller/keyboard controller (EC/KBC) 113, and an EEPROM (electrically traceable programmable ROM) 114.

The CPU 101 is a processor for controlling the behavior of each portion of the electronic apparatus (laptop PC1) 10.

The CPU 101 executes BIOS stored in the BIOS-ROM 107. BIOS is a program for controlling the hardware.

The Northbridge 102 is a bridge device that connects the local bus on the CPU 101 and the Southbridge 104. A memory controller that controls access to the main memory 103 is built into the Northbridge 102. The Northbridge 102 has a feature for executing communication with the GPU 105 via a PCI EXPRESS-standard serial bus and the like, for example.

The GPU 105 is a display controller that controls the LCD 17 used as the electronic apparatus (laptop PC1) 10 display monitor.

Display signals generated by this GPU 105 are transmitted to the LCD 17. The GPU 105 transmits digital image signals to an external display 1 via an HDMI control circuit 3 and HDMI terminal 2.

The HDMI terminal 2 is the external display connection terminal described above. The HDMI terminal 2 transmits uncompressed digital image signals and digital audio signals to the external display 1, such as a television, over a single cable. The HDMI control circuit 3 is an interface for transmitting digital image signals to the external display 1, which is known as an HDMI monitor, via the HDMI terminal 2.

The Southbridge 104 includes an IDE (integrated drive electronics) controller for controlling the HDD 109 and ODD 110.

Still further, the Southbridge 104 has a feature for executing communication with the sound controller 106.

The sound controller 106 is an audio source device. This outputs audio data targeted for playback to speakers 18A and 18B or the HDMI control circuit 3. The LAN controller 108 is a wired communication device that executes IEEE802.3-standard wired communications, for example. Conversely, the wireless LAN controller 112 is a wireless communication device that executes IEEE802.11g-standard wireless communications, for example. The USB controller 111A executes communications with an external device (connected via the USB connector 19) that supports the USB 2.0 standard, for example.

For example, the USB controller 111A is used for receiving image data files stored on a digital camera, for example. The card controller 111B reads and writes data to a memory card, such as an SD card, inserted into a card slot disposed in the computer (laptop PC) main body case 11.

EC/KBC 113 is a single-chip microcomputer integrated with an embedded controller for power management, and a keyboard controller for controlling the keyboard 13 and touch-pad 16. The EC/KBC 113 has a feature for turning the electronic apparatus (laptop PC) power on and off to correspond to user operations of the power button 14.

Display control in the embodiment of the present invention is performed, for example, by the CPU 101 executing a program recorded the main memory 103 or the HDD 19, and the like.

A millimeter wave communication controller 120, an antenna 22, and a transmitting/reflecting plate (which will be described as transmitting/reflecting plate 23a, transmitting/reflecting film 23b, an transmitting/reflecting plate 23c) are disposed in this embodiment to make verification of the other party (electronic apparatus) of the millimeter wave communication easier by electrically switching a direction in which it is possible to send and receive communication waves of the electronic apparatus (PC) 10, for example, between the first direction and the second direction.

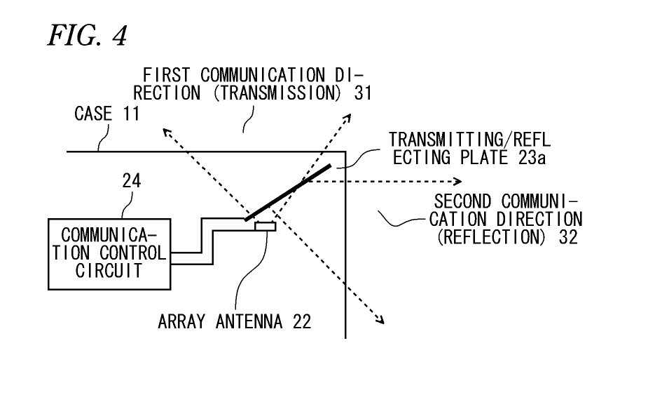

The antenna 22 is an array antenna, for example. This is described in relation to FIG. 4. Also the transmitting/reflecting plate 23 transmits and reflects millimeter waves as described below.

The millimeter wave communication controller 120 electrically controls the antenna 22 and the transmitting/reflecting plate 23.

FIG. 4 is an explanatory view of one example of a configuration of an electronic apparatus according to the embodiment of the present invention.

As described above, the numeral 11 denotes the case of the electronic apparatus (PC) 10. The numeral 22 denotes the array antenna; the numeral 23a denotes the transmitting/reflecting plate; the numeral 24 denotes the communication control circuit. This communication control circuit 24 is included in the millimeter wave communication controller 120, for example.

The numeral 31 denotes the first communication direction (transmission) in which millimeter wave communication of the electronic apparatus (PC) is possible. The numeral 32 denotes a second communication direction (reflection) in which millimeter wave communication of the electronic apparatus (PC) is possible.

The array antenna 22, transmitting/reflecting plate 23a, and communication control circuit 24 are housed, for example, inside the case 11 of the electronic apparatus (PC).

In the embodiment, the array antenna 22 transmits and receives millimeter waves to and from the first communication direction 31, which has strong directivity as described above, for example.

A general array antenna will now be described.

As described above, the array antenna is an antenna having strong directivity.

Generally, an array antenna has multiple arrays of smaller antenna in a plane shape, so the quantity can reach as high as several thousand pieces. Output of each antenna is weak. However, high output can be obtained by synthesizing a plurality of antenna.

In a case where radio waves (millimeter waves) are output simultaneously from the small antenna, of the array antenna above, the synthesized moves in a direction that is at a right angle to the antenna surface. The synthesized wave is output in an oblique direction from the antenna surface by shifting radio wave phases of each small antenna, described above.

Also, with millimeter wave reception, it is possible to investigate an incident direction of radio waves (millimeter waves) by investigating a difference phase of each of the small antennas.

Also, a transmitting/reflecting plate 23a is configured in the embodiment; millimeter waves transmitted and received by the array antenna 22 are transmitted and reflected, in a direction that millimeter waves are transmitted and received from the first communication direction, in other words the array antenna 22, for example.

Also the transmitting/reflecting plate 23a electrically controls millimeter wave reflection and transmission.

For example, when reflecting millimeter waves, the transmitting/reflecting plate 23a becomes a mirror surface, substantially like metal and the like, and is electrically controlled to reflect the millimeter wave. Also, when transmitting millimeter waves, a gap smaller than a waveform of the millimeter wave is formed in the mirror surface that is like the metallic piece above and the like, for example, and is electrically switched to allow the millimeter wave to pass there through.

Generally, electromagnetic waves have a property that they do not pass through a metallic surface whose gap is smaller than a wavelength, and are reflected.

In this embodiment, using this property, a mirror surface is configured in the transmitting/reflecting plate 23a by incorporating a panel having a plurality of gaps. It is possible to switch transmission and reflection by electrically opening a hole in the panel in transmitting/reflecting plate 23a.

In this embodiment, the transmitting/reflecting plate 23a is controlled by electrically switching reflection and transmission of millimeter waves in the transmitting/reflecting plate 23, for example.

For example, an electric signal is used to control switching like a liquid crystal shutter that switches to reflect or to transmit light.

In the embodiment, the transmitting/reflecting plate 23a controlled by the communication control circuit 24 is controlled to switch to transmit or to reflect millimeter waves.

When the communication control circuit 24 controls the transmitting/reflecting plate 23a to switch to transmit the millimeter wave, the millimeter wave passes through at the transmitting/reflecting plate 23a. For that reason, the transmitting and receiving directions of millimeter waves at the array antenna 22 are the first communication direction denoted by the numeral 31, as shown in the drawings.

When the communication control circuit 24 controls the transmitting/reflecting plate 23a to switch to reflect the millimeter wave, the millimeter wave is reflected at the transmitting/reflecting plate 23a. For that reason, the transmitting and receiving directions of the millimeter wave at the array antenna 22 is the second communication direction denoted by the numeral 32, as shown in the drawings.

In the embodiment, the controlled switching of the transmission and reflection of the millimeter wave at the transmitting/reflecting plate 23a, described above, is performed in cycles of several milliseconds to approximately 1 second intervals.

In this embodiment, if an electronic apparatus of another party of communication is verified, for example, control of the transmitting/reflecting plate 23a is fixed at the transmission side when the direction of the timing that the other party of the communication is verified, in other words, when the other party of the communication is verified in a timing to control the switch to the transmission of the millimeter wave. Also, when the other party of the communication is verified at a timing to control to switch to reflection, the control of the transmitting/reflecting plate 23a is fixed at the reflecting side. This enables data communication with the other-party electronic apparatus.

As described above, in the embodiment, if the transmitting/reflecting plate 23a is in a transmitting state, radio waves are reflected in the first communication direction 31, and communication is possible in substantially the same way as when there is no transmitting/reflecting plate 23a.

Also, if the transmitting/reflecting plate 23a is in a reflective state, millimeter waves are reflected, and radio waves are reflected in the second communication direction 32; communication with the other-party electronic apparatus is possible in the second communication direction 32.

This makes it easier to verify the other-party electronic apparatus.

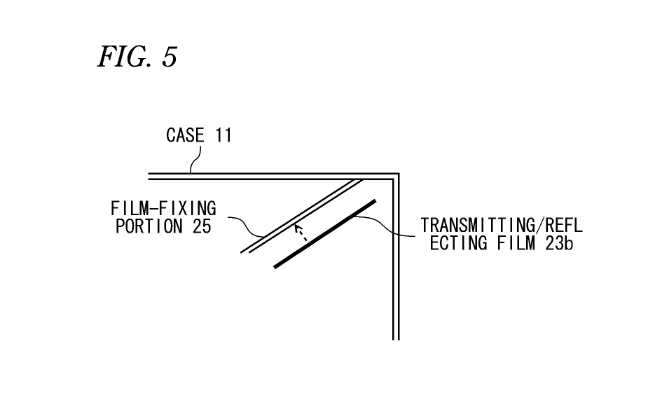

FIG. 5 is an explanatory view of another example of a configuration of an electronic apparatus according to the embodiment of the present invention.

In the embodiment, a film-shaped transmitting/reflecting film 23b is disposed instead of the transmitting/reflecting plate 23a. Also, here a film-fixing portion 25 is disposed that is substantially transparent to a degree that allows millimeter waves to pass therethrough. The film-fixing portion 25 is supported by the case 11, for example.

The transmitting/reflecting film 23b is affixed to the film-fixing portion 25. In the same way as the transmitting/reflecting plate 23a, this is instructed by the communication control circuit 24, and controlled to switch transmission/reflection millimeter waves transmitted and received by the array antenna 22.

In the embodiment, by using a film-shaped transmitting/reflecting film 23b, the film can be disposed in the electronic apparatus 10 flexibly and at low cost.

When using a film-shaped transmitting/reflecting film 23b, the film affixed to a structural body inside the case 11, as shown in the drawings. Therefore, it is possible easily to fasten and dispose the film-fixing portion 25 affixed with the transmitting/reflecting film 23b.

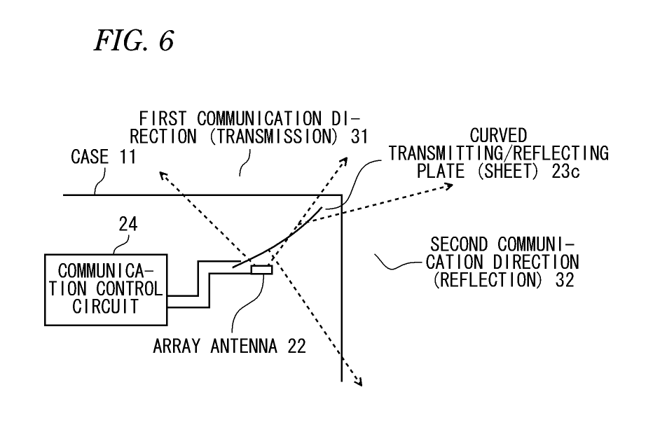

FIG. 6 is an explanatory view of another example of a configuration of an electronic apparatus according to the embodiment of the present invention.

In the embodiment, a curved transmitting/reflecting plate or a curved transmitting/reflecting sheet 23c is disposed instead of the transmitting/reflecting plate 23a.

In the same way as described above, when the communication control circuit 24 controls the curved transmitting/reflecting plate (sheet) 23c to switch to transmit a millimeter wave, the millimeter wave passes through the curved transmitting/reflecting plate (sheet) 23c. For that reason, the transmitting and receiving directions of millimeter waves in the array antenna 22 is the first communication direction 31, as shown in the drawings.

Also, when the communication control circuit 24 controls the curved transmitting/reflecting plate (sheet) 23c to switch to reflect the millimeter waves, the millimeter wave are reflected at the curved transmitting/reflecting plate (sheet) 23c. For that reason, the transmitting and receiving directions of millimeter waves at the array antenna 22 are the second communication direction 32, as shown in the drawings.

In the embodiment, the controlled switching of the transmission and reflection of the millimeter wave at the curved transmitting/reflecting plate (sheet) 23c described above, is performed in cycles of several milliseconds to approximately 1 second intervals.

If an electronic apparatus of the another party of communication is verified, for example, the control of the transmitting/reflecting plate (sheet) 23c is fixed at the transmission side when the direction of the timing that the other party of the communication was verified, in other words, when the other party of the communication was verified in the timing to control the switch to the transmission. If another party of communication is verified at a timing to control a switch to reflect the waves, the control of the transmitting/reflecting plate (sheet) 23c is fixed at the reflecting side. This enables data communication with the other-party electronic apparatus.

As described above, the transmitting/reflecting plate (sheet) 23c has a curved form such as a convex surface mirror as shown in the drawings. This makes it possible to widen a reach and a direction (range) of reflected millimeter waves, for example.

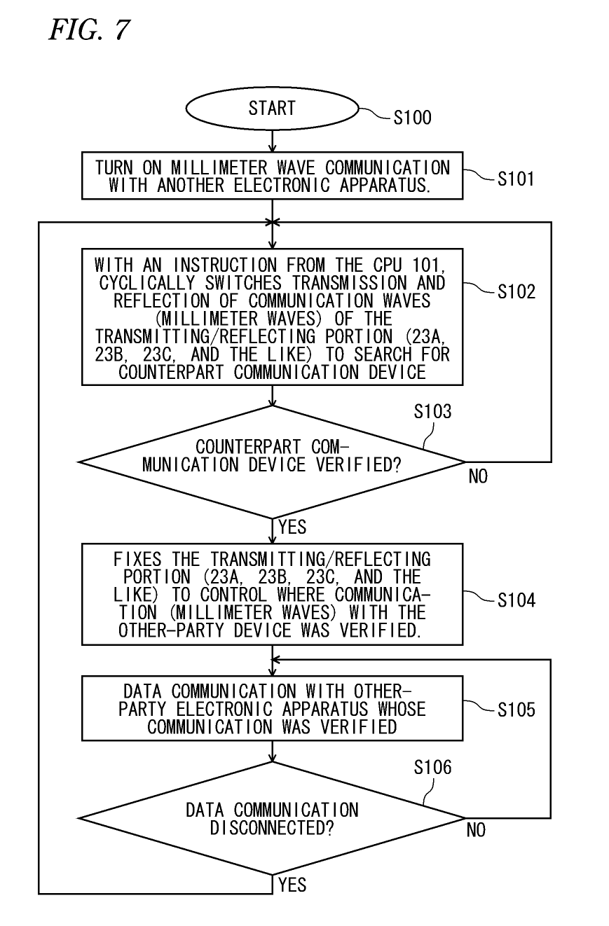

FIG. 7 is a flow chart to explain one example of behavior of an electronic apparatus according to the embodiment of the present invention.

The numeral S100 denotes a starting step here. Continue to step S101.

At step S101, millimeter wave communication with another electronic apparatus is turned on. Continue to step S102.

At step S102, with instructions from the CPU 101, transmission and reflection control for communication waves (millimeter waves) of the transmitting/reflecting portion (for example, the transmitting/reflecting plate 23a, the transmitting/reflecting sheet 23b, or the curved transmitting/reflecting plate (sheet) 23c, and the like) is cyclically switched to search for an counterpart communication device. Continue to step S103.

At step S103, it is determined whether counterpart communication device of the electronic apparatus (PC) 10 has been verified. When it has been determined that counterpart communication device of the electronic apparatus (PC) 10 has been verified, continue to step S104 (Yes). When it has been determined that counterpart communication device of the electronic apparatus (PC) 10 has not been verified, proceed to step S102 (No).

At step S104, the transmitting/reflecting portion (23a, 23b, 23c and the like) is fixed at the transmission or reflection control when millimeter wave communication with counterpart communication device has been verified, as described above. Continue to step S105.

At step S105, data communication is performed with another-party electronic apparatus whose communication has been verified. Continue to step S106.

At step S106, data communication being performed with another-party electronic apparatus is monitored to determine whether data communication has been disconnected. If it is determined that data communication has been disconnected, return to step S102 and repeat the processes described above (Yes). If it is determined that data communication has not been disconnected, return to step S105 and repeat the processes described above (No).

In this embodiment, when communication with another-party electronic apparatus is not connected, and a beacon or a connection request signal is not cyclically transmitted or received in order to find an another-party electronic apparatus, the communication control circuit 24, for example, cyclically controls to switch transmission and reflection in fixed time cycles. Therefore, even if another-party electronic apparatus is in the first direction 31 or the second direction 32, it is possible to detect and to connect the other-party electronic apparatus for data communication.

With the configuration described above, embodiments of the present invention have the effects of reducing the number of array antenna used, and of making it easier to verify another party of communication.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
an antenna configured to transmit and receive communication waves in a first direction; and
a switching module positioned in front of the antenna, the switching module configured to electrically switch the communication waves from the first direction to a second direction that differs from the first direction.

2. The apparatus of claim 1, wherein the switching module comprises a switching member configured to switch between transmission and reflection of the communication waves.

3. The apparatus of claim 1, further comprising a controller configured to control the switching module.

4. The apparatus of claim 1, wherein the switching module is further configured to:
transmit and receive the communication waves in the first direction when the switching module is configured to transmit the communication waves; and
transmit and receive the communication waves in the second direction when the switching module is configured to reflect the communication waves.

5. The apparatus of claim 1, further comprising a case configured to accommodate the antenna and the switching module.

6. The apparatus of claim 1, wherein the switching module comprises a plate shape or a film shape.

7. The apparatus of claim 1, wherein the switching module comprises a curved portion.

8. The apparatus of claim 1, wherein the switching module is further configured to substantially improve directivity by switching the direction of the communication waves.

9. A method for controlling an electronic apparatus, the method comprising:
transmitting and receiving communication waves in a first direction; and
electrically switching a direction of the communication waves from the first direction to a second direction that differs from the first direction.
